(19) United States
(12) Patent Application Publication
(10) Pub. No.: US 2025/0019573 A1
(43) Pub. Date: Jan. 16, 2025

(54) OPTICAL DISPLAY DEVICE AND ADHESIVE FILM TO BE INCLUDED THEREIN

(71) Applicant: SAMSUNG SDI CO., LTD., Yongin-si Gyeonggi-do (KR)

(72) Inventors: Do Young KIM, Suwon-si (KR); Gwang Hwan LEE, Suwon-si (KR); Ji Ho KIM, Suwon-si (KR); Il Jin KIM, Suwon-si (KR)

(21) Appl. No.: 18/707,516

(22) PCT Filed: Nov. 2, 2022
(86) PCT No.: PCT/KR2022/017043

§ 371 Date: May 3, 2024

(30) Foreign Application Priority Data
Nov. 5, 2021 (KR) 10-2021-0151442

(51) Int. Cl. C09J 7/38; G02B 5/30

(52) U.S. Cl. CPC C09J 7/38; G02B 5/30; C09J 2301/302; C09J 2301/312; C09J 2301/408

(57) ABSTRACT

Provided are an optical display device and an adhesive film to be included therein. The optical display device comprises: a panel for an optical display device and an adhesive film stacked on at least one surface of the panel for an optical display device, wherein the adhesive film has a storage modulus of 0.5 MPa or less at −20° C., the adhesive film has a haze of 3% or more, and the optical display device does not include a polarization plate.

### TECHNICAL FIELD

The present invention relates to an optical display device and an adhesive film to be included therein.

### BACKGROUND ART

Environments in which optical display devices are used, stored, and manufactured are becoming harsher. There is growing interest in new optical display devices, such as wearable optical display devices, foldable optical display devices, and the like.

There is growing demand for reduction in thickness of optical display devices. Among optical display devices, an optical display device including a light emitting diode panel, such as an organic light emitting diode panel or the like, does not include a polarizing plate. However, when external light is incident on the light emitting diode panel, the external light can be reflected from the light emitting diode panel, causing poor screen display quality. Recently, an optical display device including the light emitting diode panel requires a polarizing plate corresponding to increasing demand for and interest in optical display devices capable of realizing high image quality.

In order to achieve an anti-reflection effect against external light, a polarizing plate includes a polarizer, a retardation layer stacked on one surface of the polarizer, and a protective layer stacked on the other surface of the polarizer. Although this stacked structure of the polarizing plate is essential for the anti-reflection function, there can be a problem of increase in thickness of the optical display device.

Therefore, there is a need for a means for an optical display device that can provide an anti-reflection function to the optical display device by replacing a function of a polarizing plate while providing foldable or wearable functionality thereto.

The background technique of the present invention is disclosed in Korean Patent Laid-open Publication No. 2007-0055363 and the like.

### DISCLOSURE

### Technical Problem

It is one aspect of the present invention to provide an optical display device having good flexural reliability.

It is another aspect of the present invention to provide an optical display device that secures thickness reduction and good light transmittance.

It is a further aspect of the present invention to provide a highly reliable optical display device capable of minimizing damage to an optical display device panel upon external impact.

It is yet another aspect of the present invention to provide an optical display device having improved black visibility of a screen in a non-driven state by realizing an anti-reflection function even without a polarizing plate.

It is yet another aspect of the present invention to provide an optical display device having high screen quality in a driven state.

It is yet another aspect of the present invention to provide an adhesive film providing an optical display device having the above effects.

### Technical Solution

One aspect of the present invention relates to an optical display device.

1. The optical display device includes an optical display device panel and an adhesive film stacked on at least one surface of the optical display device panel, wherein the adhesive film has a storage modulus of 0.5 MPa or less at −20° C. and a haze of 3% or more, and wherein the optical display device is free from a polarizing plate.

2. In 1, the optical display device may be free from an anti-reflection film.

3. In 1 to 2, the adhesive film may have a storage modulus of 0.5 MPa or less at 60° C.

4. In 1 to 3, the adhesive film may have a value of 0.5 to 20, as calculated according to Equation 1.

$$A \times B \qquad [ Equation 1 ]$$

(In Equation 1, A is haze of the adhesive film (unit: %) and

B is storage modulus of the adhesive film at −20° C. (unit: MPa).

5. In 1 to 4, the adhesive film may have a light transmittance of 80% or more.

6. In 1 to 5, the adhesive film may have a peel strength of 250 gf/inch or more with respect to a glass plate.

7. In 1 to 6, the adhesive film may include a matrix for the adhesive film and organic particles embedded in the matrix for the adhesive film.

Another aspect of the invention relates to an adhesive film.

8. The adhesive film may be formed of an adhesive film composition including a binder, a curing agent, and organic particles, wherein the adhesive film has a storage modulus of 0.5 MPa or less at −20° C. and a haze of 3% or more.

9. In 8, the organic particles may include non-core shell type organic particles.

10. In 8 to 9, the organic particles may have an average particle diameter (D50) of 0.1 μm to 30 μm.

11. In 8 to 10, the organic particles may include at least one selected from among polymethyl methacrylate; polystyrene; a copolymer of methyl methacrylate and styrene; or a copolymer of a monomer mixture including methyl methacrylate and styrene.

12. In 8 to 11, the organic particles may be present in an amount of 0.001 parts by weight to 1.5 parts by weight relative to 100 parts by weight of the binder.

13. In 8 to 11, the binder may be formed of a (meth)acrylic based copolymer, and the (meth)acrylic based copolymer and the curing agent may form a matrix for the adhesive film and the matrix may have a lower index of refraction than the organic particles.

14. In 13, a difference in index of refraction between the organic particles and the matrix for the adhesive film may be 1.0 or less.

15. In 8 to 14, inorganic particles may be further embedded in the adhesive film.

16. In 8 to 15, the inorganic particles may have a higher index of refraction than the organic particles.

17. In 8 to 16, the inorganic particles may include at least one selected from among silica, titania, zirconia, or alumina.

18. In any of 8 to 17, the inorganic particles may be present in an amount of more than 0 parts by weight to 10 parts by weight relative to 100 parts by weight of the binder.

19. In 8 to 18, the adhesive film may have a value of 0.5 to 20, as calculated according to Equation 1.

$$A \times B \qquad [ Equation 1 ]$$

(In Equation 1, A is haze of the adhesive film (unit: %) and

B is storage modulus of the adhesive film at −20° C. (unit: MPa).

20. In 8 to 19, the adhesive film may have a peel strength of 250 gf/inch or more with respect to a glass plate.

### Advantageous Effects

The present invention provides an optical display device having good flexural reliability.

The present invention provides an optical display device that secures thickness reduction and good light transmittance.

The present invention provides a highly reliable optical display device capable of minimizing damage to an optical display device panel upon external impact.

The present invention provides an optical display device having improved black visibility of a screen in a non-driven state by realizing an anti-reflection function even without a polarizing plate.

The present invention provides an optical display device having high screen quality in a driven state.

The present invention provides an adhesive film providing an optical display device having the above effects.

### DESCRIPTION OF DRAWINGS

FIG. 1 is a sectional view of an optical display device according to one embodiment of the present invention.

### BEST MODE

Hereinafter, embodiments of the present invention will be described in detail with reference to the accompanying drawings such that the present invention can be easily implemented by a person having ordinary knowledge in the art. It should be understood that the present invention may be embodied in different ways and is not limited to the following embodiments.

In the drawings, components unrelated to description are omitted for clear description of the invention and like components will be denoted by like reference numerals throughout the specification. Although lengths, thicknesses or widths of various components may be exaggerated for understanding in the drawings, the present invention is not limited thereto. Herein, spatially relative terms, such as “upper” and “lower”, are defined with reference to the accompanying drawings. Thus, it will be understood that the term “upper surface” can be used interchangeably with the term “lower surface”.

Herein “(meth)acryl” refers to acryl and/or methacryl.

Herein, “haze” and “light transmittance” each refer to a value measured at a wavelength of 200 nm to 800 nm, preferably at a wavelength of 550 nm.

Herein, “storage modulus” is a value measured on a specimen using a dynamic viscoelastic rheometer ARES (Anton Parr, MCR-501) under temperature sweep conditions, with an axial force of 0 N applied to the specimen, while increasing temperature from −60° C. to 90° C. at a rate of 5° C./min under conditions of a shear rate of 1 Hz and a strain of 25%, in which the specimen is prepared by stacking a plurality of adhesive films to a thickness of 500 μm and punching the stacked adhesive films using a punching machine having a diameter of 8 mm.

Herein, “average particle size (D50)” may be measured by any typical method known to those skilled in the art. For example, the average particle size (D50) means the particle diameter of organic particles or inorganic particles corresponding to 50% by volume in weight cumulative analysis by a particle size analyzer.

Herein, “peel strength” is a value measured on a specimen, which is prepared by stacking an adhesive film and a release film (for example, corona-treated polyethylene terephthalate film) on a soda lime glass plate, upon peeling a laminate of the adhesive film and the release film from the soda lime glass plate under conditions of a peeling temperature of 25° C., a peeling rate of 300 mm/min, and a peeling angle of 180°.

As used herein to represent a specific numerical range, the expression “X to Y” means “X≤ and ≤Y”.

The present invention provides an optical display device that can secure good flexural reliability, thickness reduction and good transmittance, can realize an anti-reflection function without a polarizing plate, and can secure good reliability by minimizing damage to an optical display device panel upon external impact. The present invention provides an optical display device securing improved black visibility of a screen in a non-driven state and good screen quality in a driven state.

An optical display device according to the present invention includes an optical display device panel and an adhesive film stacked on at least one surface of the optical display device panel, wherein the adhesive film has a storage modulus of 0.5 MPa or less at −20° C. and a haze of 3% or more.

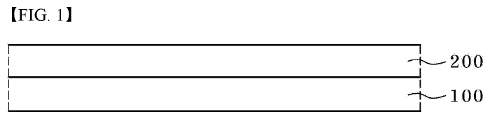

Hereinafter, an optical display device according to one embodiment of the present invention will be described with reference to FIG. 1. FIG. 1 is a partially cross-sectional view of the optical display device.

Referring to FIG. 1, the optical display device includes a light emitting diode panel (100) and an adhesive film (200) stacked on one surface of the light emitting diode panel (100). In one embodiment, the adhesive films may be stacked on a light incidence surface of the light emitting diode panel and a light exit surface of the light emitting diode panel with respect to internal light emitted from the light emitting diode panel, respectively.

Although not shown in FIG. 1, the optical display device does not include a polarizing plate. The “polarizing plate” further includes a polarizer and a protective layer stacked on at least one surface of the polarizer. Even without the polarizing plate, the optical display device including the adhesive film (200) can provide an anti-reflection function to enhance external appearance of a screen by increasing black visibility of the screen even in a non-driven state of the optical display device. In one embodiment, the optical display device may not include the polarizing plate on the light exit surface of the light emitting diode panel.

Although not shown in FIG. 1, the optical display device may not include an anti-reflection film. In the optical display device, the adhesive film may replace the anti-reflection film. The term “anti-reflection film” refers to a typical film that includes a low refractive-index layer alone or a laminate of a high-refractive index layer and a low-refractive index layer and can realize an anti-reflection function. The low-refractive index layer and the high-refractive index layer may include typical layers in anti-reflection films known to those skilled in the art. In one embodiment, the optical display device may not include the anti-reflection film on the light exit surface of the light emitting diode panel.

Hereinafter, the adhesive film (200) will be described.

By realizing the anti-reflection function, the adhesive film can improve external appearance of the optical display device even without a polarizing plate. The adhesive film may be applied to a foldable optical display device or a wearable optical display device by securing flexural reliability. The adhesive film can prevent damage to the light emitting diode panel of the optical display device from external impact by increasing impact resistance.

Although not shown in FIG. 1, the adhesive film can realize the anti-reflection function by allowing external light incident on an upper surface of the adhesive film at a viewer side (upper side in FIG. 1) to be reflected from an upper surface of the light emitting diode panel such that the reflected external light can be emitted through reflection inside the adhesive film. The anti-reflection function can be realized by organic particles satisfying conditions for haze and an average particle diameter of the adhesive film according to the present invention.

The adhesive film has a haze of 3% or more. Within this range, the anti-reflection function can be realized by stacking the adhesive film on the upper surface of the light emitting diode panel. For example, the adhesive film may have a haze of 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, or 70%. Preferably, the adhesive film has a haze of 3% to 70%, preferably 10% to 65%.

The adhesive film has a storage modulus of 0.5 MPa or less at −20° C. Within this range, the adhesive film can realize flexural reliability. An adhesive film having a storage modulus of greater than 0.5 MPa at −20° C. can suffer from cracking upon evaluation of flexural reliability. For example, the adhesive film may have a storage modulus of 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.24, 0.25, 0.26, 0.27, 0.28, 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, or 0.5 MPa. Preferably, the adhesive film has a storage modulus of 0.01 MPa to 0.3 MPa, more preferably 0.05 MPa to 0.2 MPa.

The adhesive film may have a light transmittance of 80% or more, for example, 80, 81, 82, 83, 84, 85, 86, 87, 88, 89, 90, 91, 92, 93, 94, 95, 96, 97, 98, 99, or 100%, preferably 85% to 99%. Within this range, the adhesive film does not affect light emitted from the light emitting diode panel when stacked on the upper surface of the light emitting diode panel, thereby improving screen display quality in operation of the optical display device.

In order to realize the haze and light transmittance while achieving storage modulus at −20° C. within the above range, the adhesive film includes organic particles having an average particle diameter (D50) of 1 μm to 30 μm and a matrix for the adhesive film. The organic particles are embedded in the matrix for the adhesive film.

The matrix for the adhesive film is formed of an adhesive film composition including a binder and a curing agent. The matrix for the adhesive film means a cured product formed of an adhesive film composition that does not contain organic particles and inorganic particles as described below.

The matrix for the adhesive film may have an index of refraction of 1.3 to 2.0, for example 1.3, 1.4, 1.5, 1.6, 1.7, 1.8, 1.9, or 2.0, preferably 1.4 to 1.8. Within this range, the matrix does not affect luminous efficacy of light emitted from the light emitting diode panel.

The binder may include a (meth)acrylic based copolymer, a silicone resin, and a polyurethane resin, preferably a (meth)acrylic based copolymer.

The (meth)acrylic copolymer may have a glass transition temperature of −20° C. or less, for example, −50, −49, −48, −47, −46, −45, −44, −43, −42, −41, −40, −39, −38, −37, −36, −35, −34, −33, −32, −31, −30, −29, −28, −27, −26, −25, −24, −23, −22, −21, or −20° C., preferably −50° C. to −20° C. Within this range, the adhesive film can easily realize storage modulus within the above range.

The (meth)acrylic based copolymer may include a copolymer of a monomer mixture including at least a monomer having a homopolymer glass transition temperature of −20° C. or less, for example −80, −75, −70, −65, −60, −55, −50, —49, −48, −47, −46, −45, −44, −43, −42, −41, −40, −39, −38, −37, −36, −35, −34, −33, −32, −31, −30, −29, −28, −27, −26, −25, −24, −23, −22, −21, or −20° C., preferably −80° C. to −20° C. Within this range, the monomer can assist in providing peel strength and facilitate preparation of the (meth)acrylic copolymer having the glass transition temperature within the above range. Herein, “homopolymer glass transition temperature” may be obtained from a catalog of monomers or may be measured by a typical method known to those skilled in the art.

The (meth)acrylic based monomer having a homopolymer glass transition temperature of −20° C. or less may include at least one selected from among an alkyl group-containing (meth)acrylic based monomer or a hydroxyl group-containing (meth)acrylic based monomer.

The (meth)acrylic based copolymer may include a copolymer of a monomer mixture including at least one selected from among an alkyl group-containing (meth)acrylic based monomer or a hydroxyl group-containing (meth)acrylic based monomer.

The alkyl group-containing (meth)acrylic based monomer may include an unsubstituted C₁ to C₂₀ linear or branched alkyl group-containing (meth)acrylate. For example, the alkyl group-containing (meth)acrylic monomer may include at least one selected from among methyl (meth)acrylate, ethyl (meth)acrylate, propyl (meth)acrylate, n-butyl (meth)acrylate, t-butyl (meth)acrylate, iso-butyl (meth)acrylate, pentyl (meth)acrylate, hexyl (meth)acrylate, heptyl (meth)acrylate, ethylhexyl (meth)acrylate including 2-ethylhexyl (meth)acrylate and the like, octyl (meth)acrylate, isooctyl (meth)acrylate, nonyl (meth)acrylate, decyl (meth)acrylate, and lauryl (meth)acrylate.

In the monomer mixture, the alkyl group-containing (meth)acrylic monomer may be present in an amount of 70% by weight (wt %) to 99 wt %, for example 70, 71, 72, 73, 74, 75, 76, 77, 78, 79, 80, 81, 82, 83, 84, 85, 86, 87, 88, 89, 90, 91, 92, 93, 94, 95, 96, 97, 98, or 99 wt %, preferably 80 wt % to 95 wt %. Within this range, the alkyl group-containing (meth)acrylic monomer can assist in increasing adhesive strength of the adhesive film stacked on the upper surface of the light emitting diode panel, and can facilitate achieving storage modulus according to the present invention.

The hydroxyl group-containing (meth)acrylic based monomer may include a (meth)acrylate containing at least one hydroxyl group. For example, the hydroxyl group-containing (meth)acrylate may include (meth)acrylates containing C₂ to C₁₀ alkyl groups having at least one hydroxyl group. Specifically, the hydroxyl group-containing (meth)acrylate may include at least one selected from among 2-hydroxyethyl (meth)acrylate, 2-hydroxypropyl (meth)acrylate, 3-hydroxypropyl (meth)acrylate, 2-hydroxybutyl (meth)acrylate, 4-hydroxybutyl (meth)acrylate, or 6-hydroxyhexyl (meth)acrylate. Preferably, the hydroxyl-containing (meth)acrylate includes at least one selected from among 4-hydroxybutyl (meth)acrylate, 2-hydroxyethyl (meth)acrylate, 6-hydroxyhexyl (meth)acrylate, or 3-hydroxypropyl (meth)acrylate.

In the monomer mixture, the hydroxyl-containing (meth)acrylic based monomer may be present in an amount of 1 wt % to 30 wt %, for example, 1, 2, 3, 4, 5, 6, 7, 8, 9, 10, 11, 12, 13, 14, 15, 16, 17, 18, 19, 20, 21, 22, 23, 24, 25, 26, 27, 28, or 29%, preferably 5 wt % to 20 wt %, more preferably 30 wt % to 100 wt %. Within this range, the hydroxyl group-containing (meth)acrylic monomer can assist in providing peel strength with respect to the light emitting diode panel and can facilitate achieving storage modulus according to the present invention.

The monomer mixture may further include at least one selected from among an aromatic group-containing (meth)acrylic based monomer, an alicyclic group-containing (meth)acrylic based monomer, a heterocyclic group-containing (meth)acrylic based monomer, or a carboxylic acid group-containing (meth)acrylic based monomer.

The (meth)acrylic based copolymer may be prepared by a typical polymerization method using the monomer mixture. Polymerization may be realized by a typical method well known to those skilled in the art.

The curing agent can secure peel strength and strength of the matrix for the adhesive film by curing the (meth)acrylic based copolymer.

The curing agent may be a thermosetting curing agent that is cured by heat without UV irradiation and can advantageously prevent damage to light emitting diodes by UV radiation when the adhesive film is stacked on the light emitting diode panel. In one embodiment, the thermosetting curing agent may be present in an amount of 80 wt % or more, for example, 90 wt % to 100 wt %, based on the total amount of the curing agent in the adhesive film composition.

The curing agent may include an isocyanate type curing agent. The isocyanate-type curing agent can increase peel strength through reaction with hydroxyl groups of the hydroxyl group-containing (meth)acrylic copolymer.

The isocyanate type curing agent may include a bi- or higher polyfunctional, for example, bi to hexa-functional, isocyanate-type curing agent. Specifically, the isocyanate-type curing agent may include linear aliphatic isocyanate-type curing agents, for example, hexamethylene diisocyanate, pentamethylene diisocyanate, and the like; aromatic isocyanate-type curing agents, for example, toluene diisocyanate, diphenylmethane diisocyanate, phenylene diisocyanate, xylylene diisocyanate, naphthalene diisocyanate, tetramethylxylene diisocyanate, and the like; and adducts thereof. The isocyanate-type curing agents containing linear aliphatic groups, for example, hexamethylene diisocyanate, pentamethylene diisocyanate, and the like, provide flexible properties and can assist in improvement in foldability of the adhesive film by lowering the modulus of the adhesive film.

The curing agent may be present in an amount of 0.001 parts by weight to 10 parts by weight relative to 100 parts by weight of the (meth)acrylic based copolymer. Within this range, the adhesive film can achieve improvement in peel strength and foldability at high and low temperatures. For example, the curing agent may be present in an amount of 0.001, 0.005, 0.01, 0.05, 0.1, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.5, 2, 2.5, 3, 3.5, 4, 4.5, 5, 5.5, 6, 6.5, 7, 7.5, 8, 8.5, 9, 9.5, or 10 parts by weight, preferably 0.01 to 0.5 parts by weight, more preferably 0.01 to 0.1 parts by weight, relative to 100 parts by weight of the (meth)acrylic based copolymer.

The adhesive film composition may further include a silane coupling agent to further increase peel strength with respect to an adherend.

The silane coupling agent may include any type of silane coupling agent known to those skilled in the art. The silane coupling agent may be present in an amount of 0.001 to 1 part by weight, specifically 0.003 to 1 part by weight, more specifically 0.005 to 1 part by weight, relative to 100 parts by weight of the binder.

The adhesive film composition may further include additives.

The additives may include at least one selected from among antistatic agents, surfactants, curing accelerators, ionic liquids, lithium salts, inorganic fillers, softeners, molecular weight modifiers, antioxidants, anti-aging agents, stabilizers, adhesion imparting resins, modifying resins (polyol resins, phenolic resins, acrylic resins, polyester resins, polyolefin resins, epoxy resins, epoxidation polybutadiene resins, and the like), leveling agents, defoaming agents, plasticizers, dyes, pigments (coloring pigments, sieving pigments, and the like), treatment agents, UV blocking agents, fluorescent whitening agents, dispersants, heat stabilizers, light stabilizers, UV absorbents, coagulants, or lubricants.

The matrix for the adhesive film may have a lower index of refraction than the organic particles. This relationship can help the adhesive film reach the above range of haze. In one embodiment, a difference in index of refraction between the organic particles and the matrix for the adhesive film may be 1.0 or less, for example, 0.001, 0.005, 0.01, 0.05, 0.1, 0.15, 0.2, 0.25, 0.3, 0.35, 0.4, 0.45, or 0.5, and preferably 0.001 to 0.5. This relationship can help the adhesive film reach the above range of haze.

The organic particles may have an average particle diameter (D50) of 0.1 m to 30 μm. Within this range, the organic particles do not increase storage modulus of the adhesive film and can realize the haze of the adhesive film within the above range while improving light transmittance of the adhesive film. By including micro-particles having an average particle diameter (D50) within this range, the adhesive film according to the present invention provides an anti-reflection function by increasing the haze of the adhesive film while improving flexural reliability thereof. For example, the organic particles may have an average particle diameter (D50) of 0.1, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, or 30 μm, preferably 0.5 μm to 20 μm, preferably 1 m to 10 μm.

The organic particles may have an index of refraction of 1.3 to 2.0, for example 1.3, 1.35, 1.4, 1.45, 1.5, 1.55, 1.6, 1.65, 1.7, 1.75, 1.8, 1.85, 1.9, 1.95, or 2.0, preferably 1.4 to 1.8. Within this range, the organic particles can assist in achieving the above range of haze of the adhesive film.

The organic particles are non-core shell type organic particles, which may include spherical or non-spherical amorphous particles, preferably spherical particles. In one embodiment, the organic particles, preferably non-core shell type organic particles, may be present in an amount of 50 wt % or more, for example, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %, based on the total amount of particles (including both inorganic and organic particles) contained in the adhesive film.

The organic particles may be formed of polymethyl methacrylate; polystyrene; a copolymer of methyl methacrylate and styrene; or a copolymer of a monomer mixture including methyl methacrylate and styrene, without being limited thereto.

As will be described below, after being contained in the adhesive film composition, the organic particles may be subjected to a predetermined process to form the adhesive film according to the present invention. Accordingly, the organic particles may be present in an amount of 0.001 parts by weight to 1.5 parts by weight, for example, 0.001, 0.005, 0.01, 0.05, 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, 1.1, 1.2, 1.3, 1.4, or 1.5 parts by weight, preferably 0.01 parts by weight to 1 part by weight, relative to 100 parts by weight of the binder. Within this range, the organic particles can improve flexural reliability by preventing of increasing storage modulus of the adhesive film at −20° C., can prevent light transmittance degradation, and can help to manufacture an adhesive film with a uniform surface.

The adhesive film may further include inorganic particles.

In the adhesive film, the inorganic particles can be hybridized with the organic particles to achieve uniformity of light transmittance and haze of the adhesive film.

The inorganic particles may have a higher index of refraction than the organic particles and may have an index of refraction of 1.3 to 2.0, for example, 1.3, 1.4, 1.5, 1.6, 1.7, 1.8, 1.9, or 2.0, preferably 1.4 to 1.8. Within this range, the inorganic particles can help the adhesive film achieve the above range of haze.

The inorganic particles are nanosize particles and may have an average particle diameter (D50) of 0 nm to 10 μm. Within this range, the inorganic particles can secure inherent effects thereof without affecting storage modulus and haze of the adhesive film. For example, the inorganic particles may have an average particle diameter (D50) of greater than 0 nm, 5, 10, 15, 20, 25, 30, 35, 40, 45, 50, 55, 60, 65, 70, 75, 80, 85, 90, 95, 100, 110, 120, 130, 140, 150, 160, 170, 180, 190, 200, 210, 220, 230, 240, 250, 260, 270, 280, 290, 300, 310, 320, 330, 340, 350, 360, 370, 380, 390, 400, 410, 420, 430, 44, 450, 460, 470, 480, 490, 500, 510, 520, 530, 540, 550, 560, 570, 580, 590, 600, 610, 620, 630, 640, 650, 660, 670, 680, 690, 700, 710,720, 730, 740, 750, 760, 770, 780, 790, 800, 810, 820, 830, 840, 850, 860, 870, 880, 890, 900, 910, 920, 930, 940, 950, 960, 970, 980, 990, 1,000 nm, 1, 2, 3, 4, 5, 6, 7, 8, 9, or 10 μm, preferably 0.1 nm to 300 nm, more preferably 0.1 nm to 150 nm, more preferably 1 nm to 50 nm.

The inorganic particles may include silica, titania, zirconia, alumina, and the like, without being limited thereto. Preferably, zirconia particles are used as the inorganic particles to further improve peel strength and cohesion.

The inorganic particles may be present in an amount of 0 to 10 parts by weight, for example, 0, 0.01, 0.02, 0.03, 0.04, 0.05, 0.06, 0.07, 0.08, 0.09, 0.1, 0.5, 1, 2, 3, 4, 5, 6, 7, 8, 9, or 10 parts by weight, preferably 0 to 10 parts by weight, preferably 0.01 parts by weight to 5 parts by weight, more preferably 0.01 parts by weight to 1 part by weight, still more preferably 0.01 parts by weight to 0.5 parts by weight, relative to 100 parts by weight of the binder. Within this range, the inorganic particles can prevent deterioration in light transmittance of the adhesive film while securing flexural reliability and the anti-reflection function of the adhesive film. In one embodiment, the inorganic particles may be present in an amount of 50 wt % or less, for example, 0 wt % to 50 wt %, greater than 0 wt % to 50 wt %, based on the total amount of particles (including both the inorganic particles and the organic particles) contained in the adhesive film.

The adhesive film composition may further include a solvent. The solvent can improve applicability of the composition. The solvent may be any typical solvent including methyl ethyl ketone and the like known to those skilled in the art. The solvent may be present as a balance component of the composition excluding solids.

The adhesive film composition may further include typical additives, for example, coagulants, antistatic agents, surfactants, ionic liquids, lithium salts, inorganic fillers, softeners, molecular weight modifiers, antioxidants, anti-aging agents, stabilizers, leveling agents, defoaming agents, plasticizers, dyes, pigments (coloring pigments, sieving pigments, and the like), treatment agents, UV blocking agents, fluorescent whitening agents, dispersants, heat stabilizers, light stabilizers, UV absorbents, lubricants, and the like.

The additives may be present in an amount of 0.001 parts by weight to 1 part by weight, specifically 0.003 parts by weight to 1 part by weight, more specifically 0.005 parts by weight to 1 part by weight, relative to 100 parts by weight of the binder. Within this range, the additives can secure inherent effects thereof without affecting peel strength and reliability of the adhesive film.

The adhesive film may be prepared as a pressure sensitive adhesive film by coating the adhesive film composition to a predetermined thickness on a base film, followed by heat curing (aging). In one embodiment, the base film may include a polyester film, such as polyethylene terephthalate and the like, without being limited thereto. The base film may have a thickness of 10 μm to 100 μm, preferably 50 m to 80 μm. In one embodiment, heat curing may be performed by leaving the coated composition at 20° C. to 40° C. for 1 to 5 days.

The adhesive film may have a storage modulus of 0.5 MPa or less at 60° C., for example, 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.27, 0.28.24, 0.25, 0.26, 0.27, 0.28. 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, or 0.5 MPa, preferably 0.001 MPa to 0.1 MPa. Within this range, the adhesive film can secure flexural reliability at high temperature.

The adhesive film may have a storage modulus of 0.5 MPa or less at 25° C., for example 0.01, 0.02, 0.03, 0.04, 0.05, 0.06, 0.07, 0.08, 0.09, 0.1, 0.11, 0.12, 0.13, 0.14, 0.15, 0.16, 0.17, 0.18, 0.19, 0.2, 0.21, 0.22, 0.23, 0.27, 0.28.24, 0.25, 0.26, 0.27, 0.28. 0.29, 0.3, 0.31, 0.32, 0.33, 0.34, 0.35, 0.36, 0.37, 0.38, 0.39, 0.4, 0.41, 0.42, 0.43, 0.44, 0.45, 0.46, 0.47, 0.48, 0.49, or 0.5 MPa, preferably 0.001 MPa to 0.1 MPa. Within this range, the adhesive film can secure flexural reliability at room temperature and can improve reliability of the optical display device.

The adhesive film may have a peel strength of 250 gf/inch or more, preferably 250 gf/inch to 800 gf/inch, with respect to a glass plate (for example, a soda lime glass plate). Within this range, the adhesive film may be adhered to the light emitting diode panel to provide good reliability.

The adhesive film may have a value of 0.5 to 20, for example, 0.5, 0.6, 0.7, 0.8, 0.9, 1, 1.5, 2, 2.5, 3, 3.5, 4, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or 20, preferably 0.5 to 15, as calculated according to Equation 1. Within this range, when applied to an optical display device not including a polarizing plate, the adhesive film can provide the anti-reflection function while improving flexural reliability.

$$A \times B \qquad [ Equation 1 ]$$

(In Equation 1,
A is haze of the adhesive film (unit: %) and
B is storage modulus of the adhesive film at −20° C. (unit: MPa)).

The adhesive film may have a thickness of 10 μm to 100 μm, preferably 10 m to 50 μm. Within this range, the adhesive film can be used in an optical display device.

Next, the light emitting diode panel 100 will be described.

The light emitting diode panel may include inorganic light emitting diodes, organic light emitting diodes, or hybrid inorganic-organic light emitting diodes to emit light for operation of the display device.

In one embodiment, the light emitting diode panel may include R (red), G (green), and B (blue) light emitting diodes. More specifically, the light emitting diode panel may include a hole transport layer, a light emitting layer, and an electron transport layer. For details of each of these layers, refer to typical literatures known in the art.

An optical display device may be a non-foldable optical display device, a foldable optical display device, or a wearable optical display device.

Although not shown in FIG. 1, the optical display device may further include at least one selected from among a touchscreen panel, a light diffusion film, a window film, a window, a brightness enhancement film, or a glass scatter-proofing film.

Each of the touchscreen panel, the light diffusion film, the window film, the window, the luminance enhancement film, and the glass scatter-proofing film may be placed in any location of the optical display device that does not compromise implementation of the anti-reflection function of the adhesive film.

When a display screen is touched by the hand or a pen, the touchscreen panel identifies the position of the hand or the pen, thereby enabling the display device to receive input data from the screen for specific processing. The touchscreen panel is formed of a metallic material, such as aluminum, titanium, or the like, and may have an index of refraction of 2 or more, for example, 2 to 4.

The light diffusion film increases luminous efficacy of light emitted from the light emitting diode panel and may be selected from any typical light diffusion films known to those skilled in the art.

### MODE FOR INVENTION

Next, the present invention will be described in more detail with reference to some examples. However, it should be noted that these examples are provided for illustration only and are not to be construed in any way as limiting the invention.

Details of components used in the following examples and comparative examples are as follows
A. (Meth)acrylic based copolymer: SW-3508 (Nippon Carbide Industries Co., Ltd.)
B. Curing agent: CK-102 (isocyanate type curing agent, Nippon Carbide Industries Co., Ltd.)
C1. Organic particle 1 (MSX-5Z, Sekisui Co., Ltd., polymethyl methacrylate, average particle diameter (D50): 5 μm, index of refraction: 1.5 to 1.7)
C2. Organic particle 2 (MBX, Sekisui Co., Ltd., polymethyl methacrylate, average particle diameter (D50): 5 μm, index of refraction: 1.5 to 1.7)
C3. Organic particle 3 (SBX, Sekisui Co., Ltd., polystyrene, average particle diameter (D50): 5 μm, index of refraction: 1.5 to 1.7)
D. Inorganic particle (ZA-158A, Japan Catalysts Co., Ltd., zirconia, average particle diameter (D50): 11 nm, index of refraction: 1.5 to 1.8)
E. Additives (coagulant): Acrylic acid (Daejung Chemical & Metal Co., Ltd.)

### Example 1

In a reactor, the (meth)acrylic based binder and organic particle 1 were added to a solvent, ethyl acetate, and stirred for 30 minutes. Next, the curing agent was added to the reactor and stirred for 30 minutes. Next, an adhesive film composition was prepared through sonication for 10 minutes or more.

Table 1 shows the content of each of the (meth)acrylic based binder, the organic particle 1, and the curing agent in the adhesive film composition in terms of solid content and in unit of parts by weight. In Table 1, “-” means that the corresponding component is not present.

After defoaming the prepared adhesive film composition, the composition was coated to a predetermined thickness on one surface of a first release film, that is, a PET (polyethylene terephthalate) film (thickness: 75 μm, SKC Co., Ltd.), and dried at 80° C. for 2 minutes and at 130° C. for 3 minutes to form a coating layer. As a second release film, a PET film (thickness: 75 μm, SKC Co., Ltd., corona treated) was placed on the coating layer and left for aging at 40° C. for 2 days.

As a result, an adhesive sheet in which the first release film, the adhesive film (thickness: 50 m) and the second release film were sequentially stacked was prepared.

### Example 2

An adhesive sheet was prepared in the same manner as in Example 1 except that the components of the adhesive film composition were changed as listed in Table 1.

### Examples 3 and 4

Adhesive sheets were prepared in the same manner as in Example 1 except that the components of the adhesive film composition were changed as listed in Table 1 and acrylic acid was further added as additives.

### Examples 5 to 8

Adhesive sheets were prepared in the same manner as in Example 1 except that the components of the adhesive film composition were changed as listed in Table 1.

### Comparative Examples 1 to 4

Adhesive sheets were prepared in the same manner as in Example 1 except that the components of the adhesive film composition were changed as listed in Table 1.

TABLE 1

| | | Curing | Organic particle | | Inorganic | Addi- |
|---|---|---|---|---|---|---|
| | Binder | agent | Kind | Content | particle | tive |
| Example 1 | 100 | 0.01 | Organic | 0.5 | — | — |
| | | | particle 1 | | | |
| Example 2 | 100 | 0.01 | Organic | 0.1 | — | — |
| | | | particle 1 | | | |
| Example 3 | 100 | 0.01 | Organic | 0.5 | 0.1 | 0.01 |
| | | | article 1 | | | |
| Example 4 | 100 | 0.01 | Organic | 0.1 | 0.1 | 0.01 |
| | | | particle 1 | | | |
| Example 5 | 100 | 0.01 | Organic | 0.5 | — | — |
| | | | particle 2 | | | |
| Example 6 | 100 | 0.01 | Organic | 1 | — | — |
| | | | particle 2 | | | |
| Example 7 | 100 | 0.01 | Organic | 0.5 | — | — |
| | | | particle 3 | | | |
| Example 8 | 100 | 0.01 | Organic | 1 | — | — |
| | | | particle 1 | | | |
| Comparative | 100 | 0.01 | Organic | 2 | — | — |
| Example 1 | | | particle 1 | | | |
| Comparative | 100 | 0.01 | Organic | 4 | — | — |
| Example 2 | | | particle 1 | | | |
| Comparative | 100 | 0.01 | — | — | 0.1 | — |
| Example 3 | | | | | | |
| Comparative | 100 | 0.01 | — | — | — | — |
| Example 4 | | | | | | |

The adhesive sheets prepared in Examples and Comparative Examples were evaluated as to properties listed in Table 2 and results are shown in Table 2.

(1) Haze and light transmittance (each unit: %): Each specimen was prepared by removing both release films from the adhesive sheet of the first release film/adhesive film/second release film prepared in each of Examples and Comparative Examples to obtain the adhesive film, followed by stacking the adhesive film on an alkali-free glass plate. Haze and light transmittance of the specimens were measured using a haze meter NDH-9000. In the specimens, the alkali-free glass plate had no effect on haze of the adhesive film and had a haze of 0%.

(2) Storage modulus (unit: MPa): Modulus was evaluated under temperature sweep conditions using a dynamic viscoelastic rheometer ARES (Anton Parr, MCR-501). A sample was prepared by stacking a plurality of adhesive films prepared in Examples and Comparative Examples to a thickness of 500 μm. A specimen was prepared by punching the sample using an 8 mm diameter punching machine. With an axial force of 0 N applied to the specimen through an 8 mm jig, measurement was performed while increasing temperature from −60° C. to 90° C. at a rate of 5° C./min under conditions of a shear rate of 1 Hz and a strain of 25%. Storage modulus was measured at temperatures of −20° C. and 60° C.

(3) Peel strength (unit: gf/inch): A specimen was prepared by cutting the adhesive sheet of the first release film/adhesive film/second release film prepared in each of Examples and Comparative Examples into a rectangular shape having a size of 2.5 cm×10 cm (width×length), peeling off the first release film from the adhesive sheet, and sequentially attaching the adhesive film and the second release film to a soda lime glass plate, followed by autoclaving.

The specimen was attached to a peel strength measurement device, Texture Analyzer (TA Instruments) and peel strength was measured upon peeling a laminate of the adhesive film and the second release film from the soda lime glass plate under conditions of a peeling temperature of 25° C., a peeling rate of 300 mm/min, and a peeling angle of 180°

(4) Appearance: Both release films were peeled off of the adhesive sheet prepared in each of Examples and Comparative Examples and the adhesive film was observed with the naked eye to determine whether there was any agglomeration of particles. Uniform distribution of the particles without agglomeration was rated as “good” and uneven distribution and agglomeration of the particles was evaluated as “poor”.

(5) Flexural reliability: A specimen was prepared by removing the first release film and the second release film from each adhesive sheet and stacking PET films (thickness: 50 m) on both surfaces of the adhesive film. Then, the specimen was folded in half and placed within a SUS static folding jig with a gap of 3 mm (1.5 R), and was left at 25° C. for 3 days. Then, the folded surface of the adhesive film was observed through the naked eye to check whether there was any deformation (lifting, stretching, bubbling, and the like) in the adhesive film.

(6) Impact resistance (unit: cm): A specimen was prepared by peeling off the first release film from each of the adhesive sheets and stacking a PET film (thickness: 50 m) on an exposed surface of the adhesive film. The specimen was placed on a flat floor such that the second release film was placed at the top, followed by dropping a BIC pen (cross-section: circular diameter: 0.7 mm) onto the second release film. Then, a first height at which a pen mark inside the PET film (adhesive bonding surface) was first visible from the surface of the specimen from which the PET film was peeled off was checked. A higher first height indicates better impact resistance and a specimen having a first height of 4 cm or more in impact resistance evaluation can be used in practice.

TABLE 2

| | | Light | Storage modulus | | Peel | | Flexural | Impact | |
|---|---|---|---|---|---|---|---|---|---|
| | Haze | Transmittance | −20 | 60 | strength | Appearance | reliability | resistance | Eq. 1 |
| Example 1 | 35 | 92 | 0.09 | 0.02 | 600 | Good | OK | 5 | 3.15 |
| Example 2 | 12 | 92 | 0.07 | 0.02 | 750 | Good | OK | 4 | 0.84 |
| Example 3 | 35 | 92 | 0.12 | 0.02 | 650 | Good | OK | 6 | 4.2 |
| Example 4 | 12 | 92 | 0.09 | 0.02 | 750 | Good | OK | 5 | 1.08 |
| Example 5 | 21 | 91 | 0.09 | 0.02 | 600 | Good | OK | 5 | 1.89 |
| Example 6 | 35 | 91 | 0.12 | 0.02 | 300 | Good | OK | 6 | 4.2 |
| Example 7 | 40 | 87 | 0.12 | 0.02 | 400 | Good | OK | 5 | 4.8 |
| Example 8 | 62 | 92 | 0.2 | 0.02 | 250 | Good | OK | 6 | 12.4 |
| Comparative | 80 | 93 | 0.7 | 0.02 | 150 | Good | NG | 7 | 56 |
| Example 1 | | | | | | | | | |
| Comparative | 100 | 94 | Unmeasurable | Unmeasurable | Unmeasurable | Bad | NG | 9 | — |
| Example 2 | | | | | | | | | |
| Comparative | 2 | 91 | 0.08 | 0.02 | 800 | Good | OK | 3 | 0.16 |
| Example 3 | | | | | | | | | |
| Comparative | 0.5 | 91 | 0.09 | 800 | 800 | Good | OK | 3 | 0.045 |
| Example 4 | | | | | | | | | |

As shown in Table 2, the adhesive films of the present invention had a haze of 3% or more and exhibited good flexural reliability. Accordingly, the adhesive film according to the present invention exhibited good properties in terms of peel strength, external appearance and impact resistance. Accordingly, although not shown in Table 2, an optical display device including the adhesive film according to the present invention is expected to exhibit good flexural reliability, good reliability by minimizing damage to an optical display device panel from external impact, improved black visibility of a screen in a non-driven state by realizing an anti-reflection function even without a polarizing plate, and good screen quality in a driven state.

Conversely, the adhesive films of Comparative Examples 1, 3 and 4 failed to satisfy the features of the present invention. Since the adhesive film of Comparative Example 2 contained an excessive amount of organic particles and thus could not be successfully formed, it was not possible to measure modulus, peel strength and the like.

It should be understood that various modifications, changes, alterations, and equivalent embodiments can be made by those skilled in the art without departing from the spirit and scope of the invention.

1. An optical display device comprising:
an optical display device panel; and
an adhesive film stacked on at least one surface of the optical display device panel,
wherein the adhesive film has a storage modulus of 0.5 MPa or less at −20° C. and a haze of 3% or more, and
wherein the optical display device is free from a polarizing plate.

2. The optical display device as claimed in claim 1, wherein the optical display device is free from an anti-reflection film.

3. The optical display device as claimed in claim 1, wherein the adhesive film has a storage modulus of 0.5 MPa or less at 60° C.

4. The optical display device as claimed in claim 1, wherein the adhesive film has a value of 0.5 to 20, as calculated according to Equation 1:
$$A \times B \qquad [ Equation 1 ]$$
(In Equation 1, A is haze of the adhesive film (unit: %) and B is storage modulus of the adhesive film at −20° C. (unit: MPa)).

5. The optical display device as claimed in claim 1, wherein the adhesive film has a light transmittance of 80% or more.

6. The optical display device as claimed in claim 1, wherein the adhesive film has a peel strength of 250 gf/inch or more with respect to a glass plate.

7. The optical display device as claimed in claim 1, wherein the adhesive film comprises a matrix for the adhesive film and organic particles embedded in the matrix for the adhesive film.

8. An adhesive film formed of an adhesive film composition comprising a binder, a curing agent, and organic particles,
wherein the adhesive film has a storage modulus of 0.5 MPa or less at −20° C. and a haze of 3% or more.

9. The adhesive film as claimed in claim 8, wherein the organic particles comprise non-core shell type organic particles.

10. The adhesive film as claimed in claim 8, wherein the organic particles have an average particle diameter (D50) of 0.1 μm to 30 km.

11. The adhesive film as claimed in claim 8, wherein the organic particles comprise at least one selected from among polymethyl methacrylate; polystyrene; a copolymer of methyl methacrylate and styrene; or a copolymer of a monomer mixture including methyl methacrylate and styrene.

12. The adhesive film as claimed in claim 8, wherein the organic particles are present in an amount of 0.001 parts by weight to 1.5 parts by weight relative to 100 parts by weight of the binder.

13. The adhesive film as claimed in claim 8, wherein the binder is a (meth)acrylic based copolymer, and the (meth)acrylic based copolymer and the curing agent forms a matrix for the adhesive film, the matrix for the adhesive film having a lower index of refraction than the organic particles.

14. The adhesive film as claimed in claim 13, wherein a difference in index of refraction between the organic particles and the matrix for the adhesive film is 1.0 or less.

15. The adhesive film as claimed in claim 8, wherein inorganic particles are further embedded in the adhesive film.

16. The adhesive film as claimed in claim 15, wherein the inorganic particles have a higher index of refraction than the organic particles.

17. The adhesive film as claimed in claim 15, wherein the inorganic particles comprise at least one selected from among silica, titania, zirconia, or alumina.

18. The adhesive film as claimed in claim 15, wherein the inorganic particles are present in an amount of more than 0 parts by weight to 10 parts by weight relative to 100 parts by weight of the binder.

19. The adhesive film as claimed in claim 8, wherein the adhesive film has a value of 0.5 to 20, as calculated according to Equation 1:
$$A \times B \qquad [ Equation 1 ]$$
(In Equation 1, A is haze of the adhesive film (unit: %) and
B is storage modulus of the adhesive film at −20° C. (unit: MPa)).

20. The adhesive film as claimed in claim 8, wherein the adhesive film has a peel strength of 250 gf/inch or more with respect to a glass plate.
